(19) United States
(12) Patent Application Publication
(10) Pub. No.: US 2008/0080102 A1
(43) Pub. Date: Apr. 3, 2008

(54) Tunnel magnetoresistance element, magnetic head, and magnetic memory

(75) Inventors: Takahiro Ibusuki, Kawasaki (JP); Masashige Sato, Kawasaki (JP); Shinjiro Umehara, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 11/902,832

(22) Filed: Sep. 26, 2007

(30) Foreign Application Priority Data
Sep. 28, 2006 (JP) 2006-265599

(51) Int. Cl. G11B 5/127; G11B 5/33

(52) U.S. Cl. 360/324.2; 977/947

(57) ABSTRACT

A TMR element is provided which has a large MR ratio. The TMR element has a tunnel barrier layer formed between a magnetization fixed layer and a magnetization free layer, and a cap layer disposed on the magnetization free layer. The tunnel barrier layer is formed of an MgO film. The magnetization free layer is formed of a CoFeB film. The cap layer is formed by forming a Ti film immediately above the CoFeB film such that the Ti film is in contact with the CoFeB film. This makes it possible to largely enhance the MR ratio of the TMR element. Further, by using the TMR element for a magnetic head and an MRAM, it is possible to improve the performance of magnetic heads and MRAMs.

### CROSS-REFERENCE TO RELATED APPLICATIONS

This application is based upon and claims the benefits of priority from the prior Japanese Patent Application No. 2006-265599, filed on Sep. 28, 2006, the entire contents of which are incorporated herein by reference.

### BACKGROUND OF THE INVENTION

1. Field of the Invention

This invention relates to a tunnel magnetoresistance element, a magnetic head, and a magnetic memory, and more particularly to a tunnel magnetoresistance element utilizing a tunnel magnetoresistance effect, and a magnetic head and a magnetic memory which use the tunnel magnetoresistance element.

2. Description of the Related Art

A TMR (Tunnel Magneto-Resistance) element is configured to comprise a pair of ferromagnetic layers, and a thin insulating film sandwiched therebetween as a tunnel barrier layer. The TMR element is capable of detecting a change in the electric resistance of electric current flowing from one of the ferromagnetic layers to the other through the tunnel barrier layer as a signal, by utilizing a phenomenon (TMR effect) that the electric resistance of the electric current varies with an angle formed between the respective magnetic moments of the ferromagnetic layers. By making use of the above-mentioned property thereof, recently, the TMR element has come to be used for a reading element of a magnetic head of an HDD (Hard Disk Drive), or memory elements of an MRAM (Magnetoresistive Random Access Memory), which is a magnetic memory.

Normally, the TMR element is formed by forming one ferromagnetic layer, the tunnel barrier layer, and the other ferromagnetic layer, one upon another, in the mentioned order on an antiferromagnetic layer formed over a base layer, and over the laminate of these layers, further forming a cap layer as a protective layer. In this case, the one ferromagnetic layer formed over the antiferromagnetic layer is a magnetization fixed layer the direction of magnetization of which is fixed, and the other ferromagnetic layer formed over a side of the tunnel barrier layer opposite from the one ferromagnetic layer is a magnetization free layer the direction of magnetization of which can be changed by an external magnetic field. When the magnetization directions of the layers are the same, the electric resistances of the layers including the tunnel barrier layer become lower to make it easy for electric current to flow, whereas when the magnetization directions of the layers are opposite to each other, the electric resistances of the layers become higher to make it difficult for electric current to flow. Such a difference in electric resistance is detected as a signal.

Conventionally, various studies have been made of materials for the layers that form the TMR element. In general, for example, a multilayered film of a tantalum (Ta) film and a nickel-iron (NiFe) film is used for the base layer, and an iridium-manganese (IrMn) film is used for the antiferromagnetic layer. Further, a multilayered film of a cobalt-iron (CoFe) film, a Ruthenium (Ru) film, and a CoFe film is used for the magnetization fixed layer on the antiferromagnetic layer. An aluminum oxide (AlO) film is used for the tunnel barrier layer. A CoFe film, an NiFe film, a multilayered film thereof or the like is used for the magnetization free layer. Further, a multilayered film of Ta films, a multilayered film of an NiFe film and an Ru film, or the like is used for the cap layer formed over the magnetization free layer.

Furthermore, it has been attempted to increase the magnetoresistance MR ratio of the TMR element, that is, the signal output of the TMR element by replacing the CoFe film for the magnetization free layer by a cobalt-iron-boron (CoFeB) film, or replacing the AlO film for the tunnel barrier layer by a magnesium oxide (MgO) film.

Further, conventionally, there have been proposed a TMR element which has a movement-suppressing layer containing boron (B) formed between a magnetization free layer formed of a CoFeB film, and a cap layer comprising a Ta film so as to suppress diffusion of elements of the cap layer into the magnetization free layer during predetermined heat treatment (see Japanese Unexamined Patent Publication No. 2004-63592), and a TMR element which uses an alloy film containing Ta, titanium (Ti), or the like, or an oxide conductor film e.g. of indium titanium (In T.) oxide, for a cap layer, so as to suppress variation of the switching magnetic field of the magnetization free layer caused by magnetostriction (see Japanese Unexamined Patent Publication No. 2005-85821).

As described above, conventionally, the configuration of the TMR element has been studied, and characteristics thereof have been improved to a certain degree. However, further improvement in characteristics thereof, particularly an increase in the MR ratio thereof is strongly desired of present and future TMR element so as to improve the performances of magnetic heads and MRAMs to which they are applied.

For example, when the TMR element is used for a reading element of the magnetic head, an increase in its MR ratio leads to an increase in signal strength, which improves the SN ratio (ratio between signal output and noise). Further, to control the direction of magnetization of the magnetization free layer to a predetermined direction, a magnetic material (magnetic domain control film) magnetized in a predetermined direction is formed in the reading element of the magnetic head in the vicinity of the magnetization free layer. Therefore, if the MR ratio increases, the strength of the magnetic field of the magnetic domain control film is increased, thereby making it possible to increase the stability of the operation of the reading element.

Further, when the TMR element is used for a memory element of the MRAM, by increasing the signal strength by an increase in the MR ratio of the TMR element, it is possible to suppress occurrence of reading errors and reduce power consumption.

### SUMMARY OF THE INVENTION

According to one aspect of the present invention, there is provided a TMR including a magnetization fixed layer having a direction of magnetization thereof fixed, a tunnel barrier layer formed over the magnetization fixed layer, a magnetization free layer formed over the tunnel barrier layer, and formed of a CoFeB film such that a direction of magnetization thereof is variable, and a cap layer including a Ti film, and formed over the magnetization free layer such that the Ti film is in contact with the magnetization free layer.

According to one aspect of the present invention, there is provided a magnetic head using a tunnel magnetoresistance element as a reading element, wherein the tunnel magnetoresistance element includes a magnetization fixed layer having a direction of magnetization thereof fixed, a tunnel barrier layer formed over the magnetization fixed layer, a magnetization free layer formed over the tunnel barrier layer, and formed of a CoFeB film such that a direction of magnetization thereof is variable, and a cap layer including a Ti film, and formed over the magnetization free layer such that the Ti film is in contact with the magnetization free layer.

According to one aspect of the present invention, there is provided a magnetic memory using a tunnel magnetoresistance element as a memory element, wherein the tunnel magnetoresistance element includes a magnetization fixed layer having a direction of magnetization thereof fixed, a tunnel barrier layer formed over the magnetization fixed layer, a magnetization free layer formed over the tunnel barrier layer, and formed of a CoFeB film such that a direction of magnetization thereof is variable, and a cap layer including a Ti film, and formed over the magnetization free layer such that the Ti film is in contact with the magnetization free layer.

### BRIEF DESCRIPTION OF THE DRAWINGS

FIG. 1 is a schematic cross-sectional view of an example of a TMR element.

FIG. 2 is a diagram showing the relationship between the RA and the MR ratio, which varies with the parameter of a material for cap layer.

FIG. 3 is a diagram showing the relationship between the material for the cap layer and the MR ratio.

FIG. 4 is a diagram showing the relationship between the RA and the MR ratio, which varies when a magnetization free layer is formed of a CoFe film.

FIG. 5 is a diagram showing the relationship between the material for the cap layer and the MR ratio, which varies when the magnetization free layer is formed of the CoFe film.

FIG. 6 is a diagram showing the relationship between the RA and the MR ratio, which varies when a tunnel barrier layer is formed of an AlO film.

FIG. 7 is a diagram showing the relationship between the RA and the MR ratio, which varies with the parameter of the thickness of the CoFeB film of the magnetization free layer.

FIG. 8 is a diagram showing the relationship between the thickness of the CoFeB film of the magnetization free layer and the MR ratio.

FIG. 9 is a diagram showing the relationship between the RA and the MR ratio, which varies with the parameter of the thickness of a Ti film of the material for the cap layer.

FIG. 10 is a diagram showing the relationship between the thickness of the Ti film of the material for the cap layer and the MR ratio.

FIG. 11 is a diagram showing the relationship between the Co composition of the CoFeB film of the magnetization free layer and the MR ratio.

FIG. 12 is a diagram showing the relationship between the Co composition of the CoFeB film of the magnetization free layer and the magnetostriction.

FIG. 13 is a diagram showing the relationship between the RA and the MR ratio, which varies with the parameter of the B composition of the CoFeB film of the magnetization free layer.

FIG. 14 is a diagram showing the relationship between the B composition of the CoFeB film of the magnetization free layer and the MR ratio.

FIG. 15 is a schematic front view of a magnetic head, as viewed from a surface side of the magnetic head facing toward a magnetic recording medium.

FIG. 16 is a schematic cross-sectional view of the magnetic head.

FIG. 17 is a schematic cross-sectional view useful in explaining an essential part of a film-forming process step.

FIG. 18 is a schematic cross-sectional view useful in explaining an essential part of an ion-milling process step.

FIG. 19 is a schematic cross-sectional view useful in explaining an essential part of a filling process step.

FIG. 20 is a schematic cross-sectional view of essential parts of an MRAM.

### DESCRIPTION OF THE PREFERRED EMBODIMENTS

The invention will now be described in detail with reference to drawings showing a preferred embodiment thereof.

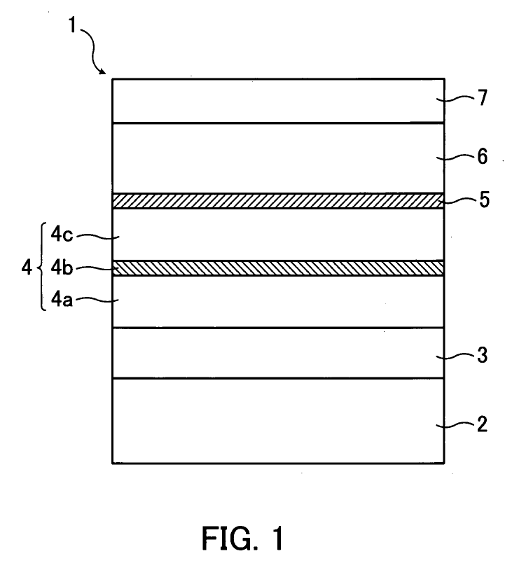

FIG. 1 is a schematic cross-sectional view of an example of a TMR element.

The TMR element 1 shown in FIG. 1 comprises a base layer 2, an antiferromagnetic layer 3, a magnetization fixed layer 4, a tunnel barrier layer 5, a magnetization free layer 6, and a cap layer 7, which are formed one upon another in the mentioned order.

The base layer 2 is formed of a multilayered film (Ta/Ru multilayered film) of a Ta film and an Ru film, a nickel chrome (NiCr) film, or a multilayered film (Ta/NiFe multilayered film) of a Ta film and a NiFe film. When the base layer 2 is formed of the Ta/Ru multilayered film, a multilayered film e.g. of a Ta film having a thickness of approximately 3 nm, and an Ru film having a thickness of approximately 2 nm is used. When the base layer 2 is formed of a NiCr film, a NiCr film having a thickness of approximately 4 nm is used. When the base layer 2 is formed of a Ta/NiFe multilayered film, a multilayered film e.g. of a Ta film having a thickness of approximately 4 nm and a NiFe film having a thickness of approximately 2 nm is used.

The antiferromagnetic layer 3 is formed e.g. by an IrMn film. The thickness of the IrMn film is approximately 7 nm, for example. Further, the antiferromagnetic layer 3 is not limitatively formed by using the IrMn film but can also be formed by using a platinum manganese (PtMn) film, a palladium platinum manganese (PdPtMn) film, or the like.

The magnetization fixed layer 4 is formed by depositing a first ferromagnetic layer 4a, a non-magnetic layer 4b, and a second ferromagnetic layer 4c one upon another (multilayered ferri layer). The first ferromagnetic layer 4a is formed of a CoFe film, and a thickness thereof is set to e.g. approximately 1.7 nm. The non-magnetic layer 4b is formed of an Ru film, and a thickness thereof is set to e.g. approximately 0.7 nm. The second ferromagnetic layer 4c is formed of a CoFeB film, and a thickness thereof is set to e.g. approximately 2 nm. It should be noted that the first ferromagnetic layer 4a of the magnetization fixed layer 4 is subjected to appropriate heat treatment later, whereby exchange coupling between the first ferromagnetic layer 4a and the antiferromagnetic layer 3 thereunder is performed to impart unidirectional magnetic anisotropy to the first ferromagnetic layer 4a.

The tunnel barrier layer 5 is formed over magnetization fixed layer 4 (on the second ferromagnetic layer 4c in the illustrated example). The tunnel barrier layer 5 is formed of an MgO film, and a thickness thereof is set to e.g. approximately 1 nm. As described above, by forming the tunnel barrier layer 5 not by an AlO film but by the MgO film, it is possible to obtain a tunnel barrier layer 5 having excellent crystallinity at lower temperature, thereby making it possible to obtain a larger TMR effect.

The magnetization free layer 6 is formed over the tunnel barrier layer 5. The magnetization free layer 6 is formed of a CoFeB film, and a thickness thereof is set to e.g. approximately 3 nm. As described above, by forming the magnetization free layer 6 not by a CoFe film but by the CoFeB film, it is possible to obtain a larger MR (magnetoresistance) ratio. It should be noted that the thickness and the composition of the CoFeB film forming the magnetization free layer 6 will be described in detail hereinafter.

The cap layer 7 is formed over the magnetization free layer 6. The cap layer 7 is formed e.g. by a Ti film, or by a Ti film formed as a lowermost layer and a metal film other than the Ti film, formed over the Ti film. For example, a multilayered film (Ti/Ta/Ru multilayered film) formed by forming a Ta film and an Ru film over the Ti film as the lowermost layer in the mentioned order can be used for the cap layer 7. When forming the cap layer 7 by the Ti/Ta/Ru multilayered film, the thickness of the Ti film is set to approximately 2 nm, that of the Ta film to approximately 5 nm, and that of the Ru film to approximately 10 nm. The cap layer 7 is formed such that the Ti film thereof is in contact with the CoFeB film forming the magnetization free layer 6. More specifically, the Ti film of the cap layer 7 is disposed immediately above the CoFeB film of the magnetization free layer 6. It should be noted that the thickness of the Ti film forming the cap layer 7 will be described in detail hereinafter.

The films forming the base layer 2, the antiferromagnetic layer 3, the magnetization fixed layer 4, the tunnel barrier layer 5, the magnetization free layer 6, and the cap layer 7 of the TMR element 1 configured as above can be formed by a sputtering method. For example, out of the above films, metal films and alloy films can be formed using a DC magnetron sputter under the conditions of an input power of 200 W to 1000 W, and an Argon (Ar) gas pressure of 0.1 Pa to 0.5 Pa. Further, out of the above films, insulating films can be formed using an RF magnetron sputter under the conditions of an input power of 200 W to 1000 W, and an Ar gas pressure of 0.1 Pa to 0.5 Pa.

After forming the films from the base layer 2 to the cap layer 7, to impart the unidirectional magnetic anisotropy to the first ferromagnetic layer 4a by exchange coupling between the antiferromagnetic layer 3 and the first ferromagnetic layer 4a, as described above, the resulting multilayer of the TMR element 1 is subjected to heat treatment for approximately 4 hours under the environment of a temperature of approximately 270° C. and a magnetic field of approximately 2.0 T. After that, the TMR element 1 is patterned into a predetermined shape e.g. according to the use of the TMR element 1.

As described above, in the TMR element 1, an MgO film is used for the tunnel barrier layer 5, and a CoFeB film is used for the magnetization free layer 6. Further, a Ti film is formed immediately above the CoFeB film to form the cap layer 7. Now, a description will be given of the results of the study of effects obtained when the TMR element is formed of such configuration of films.

First, for the study of the effects, samples X, Y, and Z having a film configuration as shown in the following table were used.

TABLE 1

| Sample | Film Configuration |
|---|---|
| X | Ta/Ru/IrMn/CoFe/Ru/CoFeB/MgO/CoFeB/Cap/Ta/Ru |
| Y | Ta/Ru/IrMn/CoFe/Ru/CoFeB/MgO/CoFe/Cap/Ta/Ru |
| Z | Ta/Ru/IrMn/CoFe/Ru/CoFeB/AlO/CoFeB/Cap/Ta/Ru |

Cap = Ta, Ti, Ru, Mg, IrMn, Al, Cu

In Sample X in Table 1, a multilayered film of a Ta film (having a thickness of approximately 5 nm) and an Ru film (having a thickness of 3 nm) forms the base layer. An IrMn film (having a thickness of approximately 7 nm) forms the antiferromagnetic layer. A multilayered film of a CoFe film (having a thickness of approximately 1.5 nm), an Ru film (having a thickness of approximately 0.7 nm), and a CoFeB film (having a thickness of approximately 2 nm) forms the magnetization fixed layer. The CoFe film functions as a pinned layer (corresponding to the above-described first ferromagnetic layer), the Ru film as a non-magnetic layer, and the CoFeB film as a reference layer (corresponding to the above-described second ferromagnetic layer). Further, an MgO film (having a thickness changed depending on the circumstances) forms the tunnel barrier layer. A CoFeB film (having a thickness changed in a range from approximately 0 nm to approximately 6 nm (exclusive of 0 nm) depending on the circumstances, and a composition changed depending on the circumstances) forms the magnetization free layer. A multilayered film of a Cap film (Cap=Ta, Ti, Ru, Mg, IrMn, Al, Cu; having a thickness changed in a range from approximately 0 nm to approximately 5 nm depending on the circumstances), a Ta film (having a thickness of approximately 5 nm), and an Ru film (having a thickness of approximately 10 nm) forms the cap layer.

Further, Sample Y in Table 1 was configured to have the same film configuration as that of Sample Y except that a CoFe film (having a thickness of approximately 3 nm) was used for the magnetization free layer. Sample Z in Table 1 was configured to have the same film configuration as that of Sample X except that an AlO film (having a thickness of approximately 1.5 nm) was used for the tunnel barrier thereof.

Each of Samples X, Y, and Z was obtained by forming associated ones of the films shown in Table 1 on a predetermined substrate (not shown in Table 1). As the substrate, there was used one having a multilayered film (Cu/Ta/Cu multilayered film) of a copper (Cu) film, a Ta film, and a Cu film, or a Ta/NiFe multilayered film, formed over an AlTiC substrate or a silicon (Si) substrate. These multilayered films are used as lower terminals of Samples X, Y, and Z. Further, the multilayered films are subjected to CMP (Chemical Mechanical Polishing) processing for smoothing, as required.

After each multilayered film has been formed over the predetermined substrate as described above, to perform the aforementioned exchange coupling, heat treatment was performed for approximately four hours at a temperature of approximately 270° C. in a magnetic field of approximately 2.0 T. After the heat treatment, to evaluate the MR characteristics of Samples X, Y, and Z, the CIP (Current In Plane) measurement was performed using 12 terminals. Furthermore, each of Samples X, Y, and Z was subjected to four-terminal formation processing, and the area resistance (=resistance×area) RA of each element and an MR ratio thereof were determined using a R—H curve formed based on the measurement by a four-terminal method under a condition that the potential of the substrate was held constant at 50 mV.

It should be noted that the four-terminal formation processing was carried out by the following procedure: First, films were formed over the substrate having a film for lower terminals formed thereon, such that the resultant multilayered film has one of the film configurations shown in Table 1. Then, a resist was applied to the whole surface of the formed film, and the shapes of the lower terminals were drawn with an exposure machine, whereafter unexposed portions were removed to leave exposed portions, whereby a resist mask was formed. Then, each film at a location upper than the multilayered film for the lower terminals was ion-milled by an ion milling machine, to thereby form the lower terminals. After removal of the resist mask, the procedure up to the ion-milling step was performed in the same manner, to form a portion corresponding to the TMR element. Successively, approximately 30 nm of a silicon oxide (SiO) film or AlO film was formed to insulate between the lower terminals and upper terminals, described hereinafter, without removing the resist mask used for the ion-milling. After forming e.g. the SiO film, the resist mask was removed to lift off the SiO film on the resist mask, and then a film for the upper terminals was formed and patterned to form the upper terminals. Using Samples X, Y, and Z, subjected to the four-terminal formation processing by using the above procedure, the R—H curves were formed by measurement to determine the RA and the MR ratio of each sample.

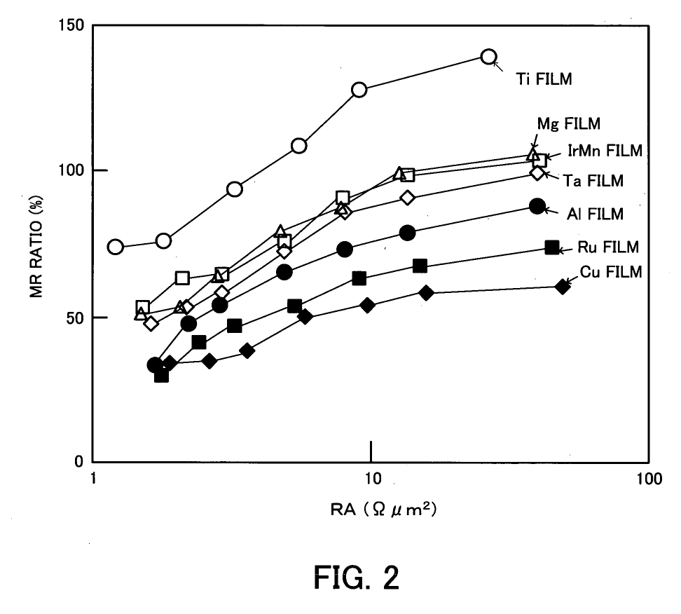

Next, the relationships between the RA and the MR ratio obtained by the measurement using Samples X, Y, and Z will be described with reference to FIGS. 2 to 6.

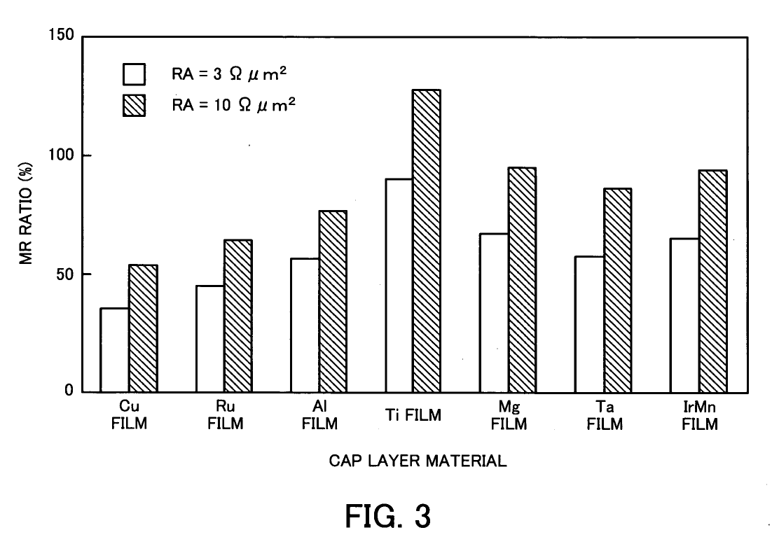

FIG. 2 is a diagram showing the relationship between the RA and the MR ratio which varies with the parameter of a material for the cap layer. FIG. 3 is a diagram showing the relationship between the material for the cap layer and the MR ratio. It should be noted that in FIG. 2, the horizontal axis represents the RA (Ωμm²), and the vertical axis represents the MR ratio (%). Further, in FIG. 3, the horizontal axis represents materials for the cap layer, and the vertical axis represents MR ratio (%) obtained when the RA is equal to 3 Ωμm² or 10 Ωμm². It should be noted that the RA is changed by changing the thickness of the tunnel barrier layer (the same applies hereinafter).

FIGS. 2 and 3 show changes in the MR ratio with respect to the RA, which were caused when Sample X in Table 1 is used, and the material for the cap layer of Sample X was changed, and the relationship between the material for the cap layers and the MR ratios, respectively. More specifically, FIGS. 2 and 3 show the relationship between the material for the cap layer and the MR ratio which was determined by forming the tunnel barrier layer by the MgO film, and the magnetization free layer by the CoFeB film having a predetermined composition and thickness, and by changing the kind of material for the cap layer formed immediately above the CoFeB film to a predetermined thickness.

It is understood from FIG. 2 that the MR ratio tends to increase with an increase in the RA, whichever of the material for the cap layers is used to form the cap layer immediately above the CoFeB film serving as the magnetization free layer. Further, when the Ti film was used as a material for the cap layer immediately above the CoFeB film as the magnetization free layer, it was possible to obtain an MR ratio larger than when the Ta film or the like material other than the Ti film was used to form the cap layer. When the Ti film was used as the material for the cap layer immediately above the CoFeB film, the MR ratio was made higher by approximately 40% at the maximum than when the Ta film or the Ru film currently in wide use was employed.

FIG. 3 shows results of comparison between the MR ratio obtained when the RA was equal to 3 Ωμm² and that obtained when the RA was equal to 10 Ωμm², which was made based on FIG. 2 for each material for the cap layer immediately above the CoFeB film of the magnetization free layer. It should be noted that a TMR element having an RA equal to or smaller than approximately 3 Ωμm² can be applied e.g. to a reading element of a magnetic head, and a TMR element having an RA larger than 10 Ωμm² can be applied e.g. to a memory element of an MRAM. As is apparent from FIG. 3, irrespective of whether the RA was equal to 3 Ωμm² or 10 Ωμm², when the Ti film was used as the material of the cap layer immediately above the CoFeB film of the magnetization free layer, the MR ratio became maximum.

As described above, by configuring the TMR element such that it has the tunnel barrier layer formed of the MgO film, the magnetization free layer formed of the CoFeB film, and the cap layer formed as the Ti film immediately above the CoFeB film of the magnetization free layer, whereby irrespective of the RA, it is possible to make the MR ratio much higher than when the Ta film or a like material other than the CoFeB layer is used for forming the cap layer immediately above the CoFeB film.

Now, a description will be given of results of measurements similar to the measurements whose results are shown in FIGS. 2 and 3, obtained when the magnetization free layer of the TMR element is formed of the CoFe film, and the tunnel barrier layer thereof is formed of the AlO film.

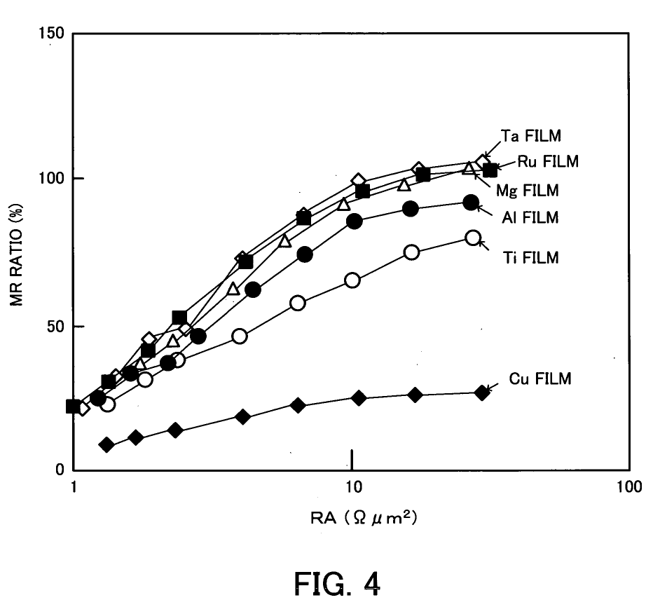

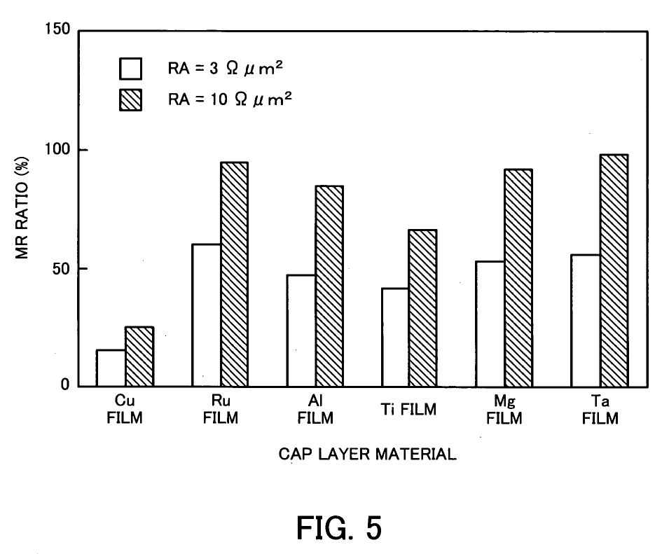

FIG. 4 is a diagram showing the relationship between the RA and the MR ratio which varies when the magnetization free layer is formed of the CoFe film. FIG. 5 is a diagram showing the relationship between the material for the cap layer and the MR ratio which varies when the magnetization free layer is formed of the CoFe film. It should be noted that in FIG. 4, the horizontal axis represents the RA (Ωμm²), and the vertical axis represents the MR ratio (%). Further, in FIG. 5, the horizontal axis represents materials for the cap layer, and the vertical axis represents the MR ratio (%) obtained when the RA is equal to 3 Ωμm² or 10 Ωμm².

FIGS. 4 and 5 show the relationships determined by measurement using Sample Y in Table 1. More specifically, FIGS. 4 and 5 show the relationship between the RA and the MR ratio, and the relationship between the material for the cap layer and the MR ratio, which were determined by forming the tunnel barrier layer by the MgO film, and the magnetization free layer by the CoFe film having a predetermined composition and thickness, and by changing the kind of material (Cap film) for the cap layer formed immediately above the CoFe film to a predetermined thickness.

It is understood from FIGS. 4 and 5 that when the magnetization free layer was formed of the CoFe film, if the Ti film was used as the material for the cap layer immediately above the CoFe film, it was possible to obtain an MR ratio larger than when the Cu film was used in place of the Ti film. However, it was found that the MR ratio tends to become smaller than when the Ta film or a like material other than the Ti film is used.

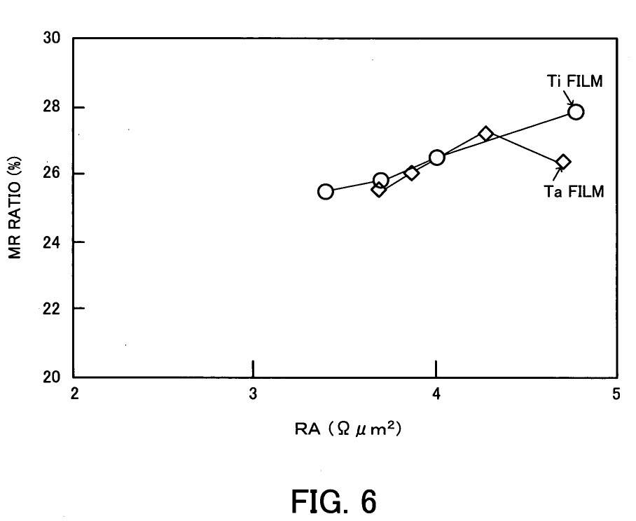

FIG. 6 is a diagram showing the relationship between the RA and the MR ratio which varies when the tunnel barrier layer is formed of the AlO film. It should be noted that in FIG. 6, the horizontal axis represents the RA (Ωμm²), and the vertical axis represents the MR ratio (%).

FIG. 6 shows the relationship determined by measurement using Sample Z in Table 1. More specifically, FIG. 6 shows the relationship between the RA and the MR ratio which was determined by forming the tunnel barrier layer by the AlO film, and the magnetization free layer by the CoFeB film having a predetermined composition and thickness, and by using the Ti film or the Ta film as the material (Cap film) for the cap layer formed immediately above the CoFeB film to a predetermined thickness.

It can be understood from FIG. 6 that the change in the MR ratio with respective to the RA, which occurs when the Ti film is used as the material for the cap layer immediately above the CoFeB film of the magnetization free layer, is approximately equal to the change in the MR ratio, which occurs when the Ta film is used as the material for the cap layer. It should be noted that in FIG. 6, within a region where the RA is more than approximately 4.5 Ωμm² the difference between the MR ratio obtained when the Ti film was used and the MR ratio obtained when the Ta film was used was caused by the difference between the optimum oxidation time of the Ti film and that of the Ta film.

As described hereinabove, from the results shown in FIGS. 2 to 6, it can be said that when the Ti film is used as the material for the cap layer immediately above the magnetization free layer, it is effective to use the CoFeB film for the magnetization free layer for the improvement of the MR ratio. Further, it can be said that when the Ti film is used as the material for the cap layer immediately above the magnetization free layer, it is more effective to use the CoFeB film for the magnetization free layer and at the same time use the MgO film for the tunnel barrier layer disposed thereunder, for the improvement of the MR ratio.

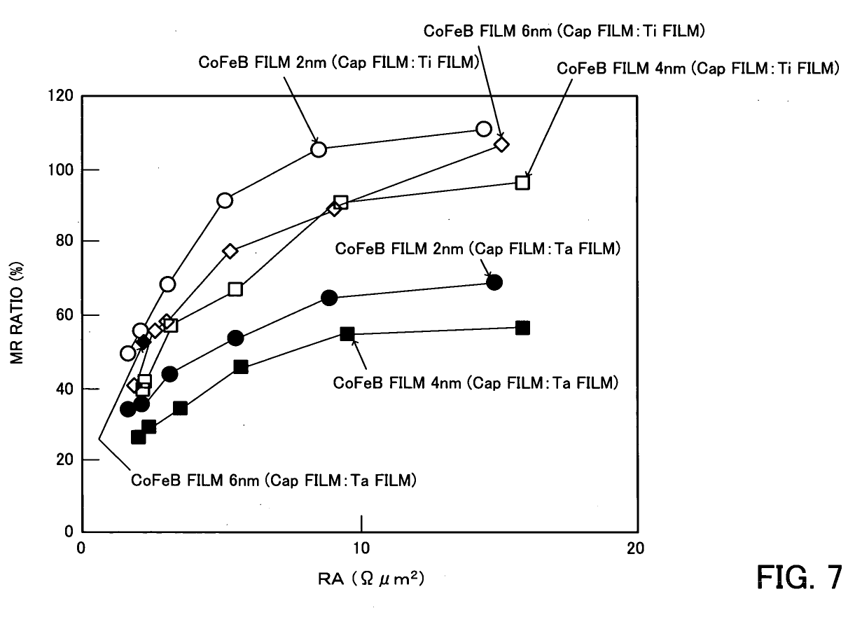

Next, the results of the studies of the thickness of the CoFeB film forming the magnetization free layer, the thickness of the Ti film, which is the material for the cap layer, and the composition of the CoFeB film will be described with reference to FIGS. 7 to 14.

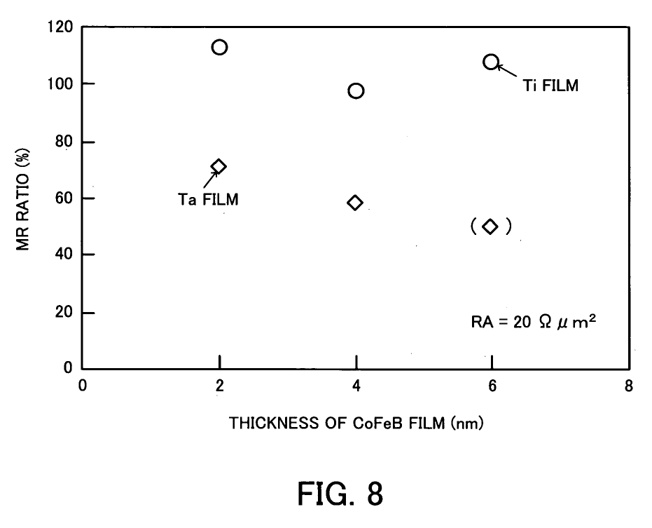

FIG. 7 is a diagram showing the relationship between the RA and the MR ratio which varies with the parameter of the thickness of the CoFeB film of the magnetization free layer. FIG. 8 is a diagram showing the relationship between the thickness and the MR ratio of the CoFeB film forming the magnetization free layer. It should be noted that in FIG. 7, the horizontal axis represents the RA (Ωμm²), and the vertical axis represents the MR ratio (%). Further, in FIG. 8, the horizontal axis represents the thickness (nm) of the CoFeB film, and the vertical axis represents the MR ratio (%) obtained when the RA was equal to 20 Ωμm² (except for some of the data).

FIGS. 7 and 8 show the relationships determined by measurement using Sample X in Table 1. More specifically, FIGS. 7 and 8 show the relationship between the RA and the MR ratio, and the relationship between the thickness of the material for the cap layer and the MR ratio, which were determined by forming the tunnel barrier layer by the MgO film, and the magnetization free layer by the CoFeB film having a predetermined composition and thickness, and forming the Ti film or the Ta film as the material (Cap film) for the cap layer formed immediately above the CoFeB film to a predetermined thickness. Here, the thickness of the CoFeB film of the magnetization free layer was changed to 2 nm, 4 nm, and 6 nm, for each of the cases where the material for the cap layer immediately above the CoFeB film was the Ti film, and the same was the Ta film.

It is understood from FIGS. 7 and 8 that when the Ta film is used as the material for the cap layer, the MR ratio tends to decrease with an increase in the thickness of the CoFeB film. On the other hand, when the Ti film is used as the material for the cap layer, the MR ratio of the TMR element hardly varies with a change in the thickness of the CoFeB film. Further, when the Ti film is used as the material for the cap layer, the MR ratio tends to become higher than when the Ta film is used as the material for the cap layer.

The CoFeB film as the magnetization free layer is required to have its thickness controlled to an optimum value according to required characteristics of the TMR element. For example, when the TMR element is used as the reading element of the magnetic head, a magnetic domain control film for controlling the direction of magnetization of the magnetization free layer is provided in the vicinity of the magnetization free layer. In this case, to make the residual magnetization of the magnetic domain control film and the magnetization of the magnetization free layer balanced between them, it is necessary to design the magnetization free layer such that it has an optimum thickness.

More specifically, in the reading element of the magnetic head, the thickness of the magnetization free layer must be optimum, but as shown in FIGS. 7 and 8, when the Ta film is used as the material for the cap layer of the reading element, the resulting MR ratio tends to be relatively small and become smaller as the thickness of the CoFeB film as the magnetization free layer is larger. In contrast, when the Ti film is used as the material for the cap layer of the reading element, as shown in FIGS. 7 and 8, the resulting MR ratio is high, and a change in the MR ratio does not occur in a manner sensitive to a change in the thickness of the CoFeB film. However, it is easy to design the magnetization free layer such that it has an optimum thickness, according to required characteristics of the reading element.

From a practical point of view, the thickness of the CoFeB film is set to approximately 0.5 nm to 6 nm, and preferably 0.5 nm to 4 nm. When the thickness of the CoFeB film is less than 0.5 nm, it becomes difficult to control the film thickness, and the CoFeB film can become an island-like film. Further, when the thickness of the CoFeB film is less than 0.5 nm, there is a possibility that the elements of the cap layer immediately above the CoFeB film diffuse into the CoFeB film to thereby or cause the magnetism thereof to be degraded or lost. In view of this point, it is preferable that the thickness of the CoFeB film is set to a value not smaller than 0.5 nm. Further, although the upper limit of the thickness of the CoFeB film should be set by taking the required characteristics of the TMR element into account, practically, it is set to a value not larger than 6 nm.

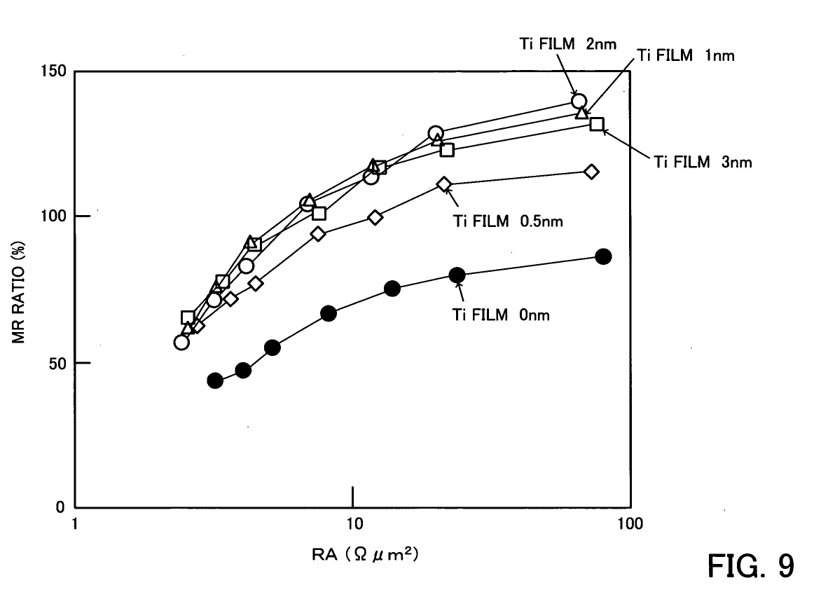

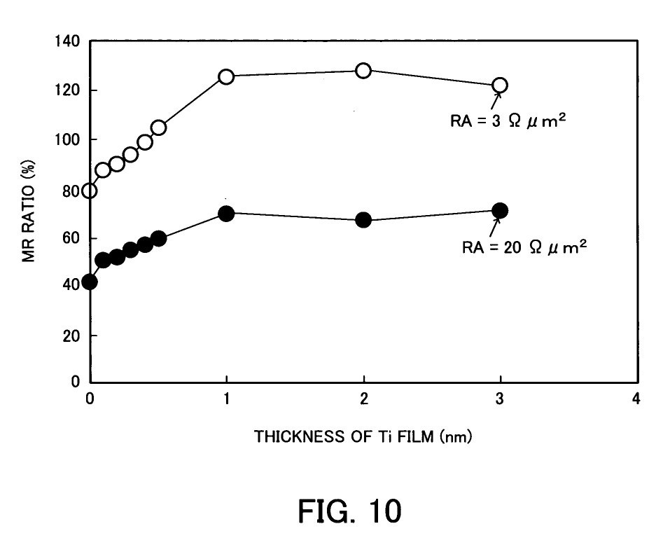

FIG. 9 is a diagram showing the relationship between the RA and the MR ratio which varies with the parameter of the thickness of the Ti film of the material for the cap layer. FIG. 10 is a diagram showing the relationship between the thickness of the Ti film of the material for the cap layer and the MR ratio. It should be noted that in FIG. 9, the horizontal axis represents the RA (Ωμm²), and the vertical axis represents the MR ratio (%). Further, in FIG. 10, the horizontal axis represents the thickness (nm) of the Ti film, and the vertical axis represents the MR ratio (%) obtained when the RA was equal to 3 Ωμm² or 20 Ωμm².

FIGS. 9 and 10 show the relationships determined by measurement using Sample X in Table 1. More specifically, FIGS. 9 and 10 show the relationship between the RA and the MR ratio, and the relationship between the thickness of the Ti film and the MR ratio, respectively, which were determined by forming the tunnel barrier layer by the MgO film, and the magnetization free layer by the CoFeB film having a predetermined composition and thickness, and by changing the thickness of the Ti film as the material (Cap film) for the cap layer formed immediately above the CoFeB film. The thickness of the Ti film was changed to 0 nm, 0.5 nm, 1 nm, 2 nm, and 3 nm.

FIGS. 9 and 10 show that irrespective of whether the RA is equal to 3 Ωμm² or 20 Ωμm², the MR ratio tends to increase monotonously until the thickness of the Ti film reaches approximately 1 nm, and when the thickness become larger than this, the MR ratio tends to be saturated.

Therefore, irrespective of the RA, if only a slight Ti film is formed, the MR ratio is effectively made higher than when no Ti film is formed. However, by taking controllability during formation of the Ti film into account, the thickness of the Ti film is set to a value not smaller than 0.5 nm, preferably not smaller than 1 nm. Particularly when the thickness of the Ti film is set to a value not smaller than 1 nm, as shown in FIGS. 9 and 10, a stable MR ratio can be obtained irrespective of the thickness. It should be noted that although the upper limit of the thickness of the Ti film should be set by taking required characteristics of the TMR element into account, practically, it is set to a value not larger than 5 nm.

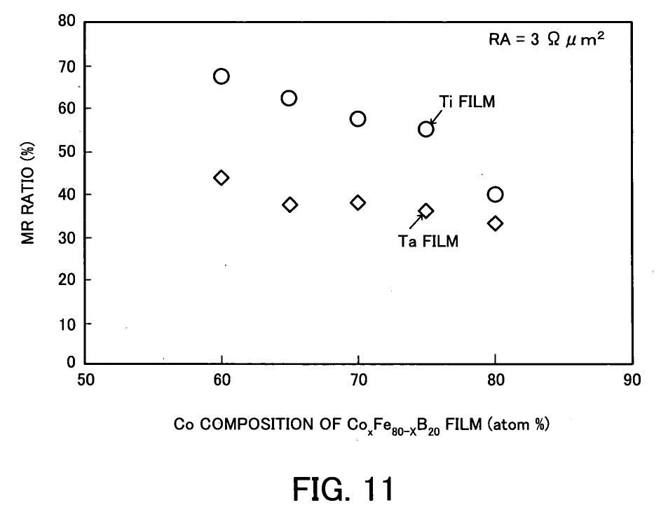

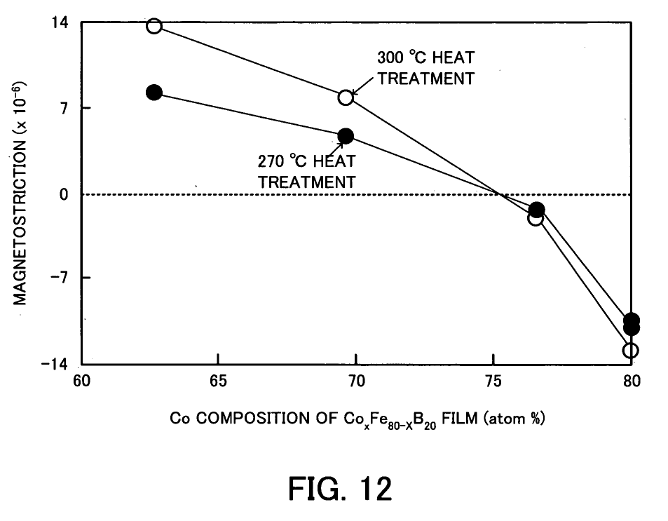

FIG. 11 is a diagram showing the relationship between the Co composition of the CoFeB film of the magnetization free layer and the MR ratio. FIG. 12 is a diagram showing the relationship between the Co composition and the magnetostriction of the CoFeB film of the magnetization free layer. It should be noted that in FIG. 11, the horizontal axis represents the Co composition (atom %) of a CoₓFe₈₀₋ₓB₂₀ film, and the vertical axis represents the MR ratio (%) obtained when the RA was equal to 3 Ωμm². Further, in FIG. 12, the horizontal axis represents the Co composition (atom %) of the CoₓFe₈₀₋ₓB₂₀ film, and the vertical axis represents the magnetostriction λ (×10⁻⁶).

FIGS. 11 and 12 show the relationship determined by measurement using Sample X in Table 1. More specifically, FIG. 11 shows the relationship between the Co composition and the MR ratio, which was determined by forming the tunnel barrier layer by the MgO film, and the magnetization free layer to a predetermined thickness while changing the composition of the CoFeB, and by forming the material (Cap film) for the cap layer formed immediately above the CoFeB film to a predetermined thickness, by the Ti film or the Ta film. Further, FIG. 12 shows the relationship between the Co composition and the magnetostriction of the CoFeB film, determined by forming the tunnel barrier layer by the MgO film, forming the Ti film having a predetermined thickness as the material for the cap layer immediately above the CoFeB film which had a composition thereof changed and had a predetermined thickness, and then performing heat treatment after the film formation, under each of the conditions of 270° C. and 300° C.

First, it is understood from FIG. 11 that although the MR ratio tends to decrease with an increase in the Co composition irrespective of whether the material for the cap layer is formed of the Ti film or the Ta film, in an inspected Co composition region, the MR ratio was higher when the Ti film was used than when the Ta film was used. In other words, when the Ti film was used as the material for the cap layer, it was possible to obtain a higher MR ratio than when the Ta film was used, without depending on the composition of the CoFeB film of the magnetization free layer.

Further, it is understood from FIG. 12 that irrespective of whether the heat treatment temperature was 270° C. or 300° C., when the Co composition was 75 atom %, i.e. when the magnetization free layer was formed of a CO₇₅Fe₅B₂₀ film, the magnetostriction was reduced to zero.

When the TMR element is used as the reading element of the magnetic head, the magnetostriction is considered to be one of the causes of magnetic anisotropy caused by a stress which is generated during formation of the TMR element. When the magnetic anisotropy is induced in the magnetization free layer, the response of the magnetization free layer to an external magnetic field is degraded, which causes noise to the reading element or degrades the sensitivity thereof. To eliminate the inconveniences, when the TMR element is used as the reading element of the magnetic head, it is desired to apply a composition, which produces almost zero magnetostriction, to the CoFeB film of the magnetization free layer of the TMR element.

As described above, it is understood from FIG. 12 that when the CO₇₅Fe₅B₂₀ film is used for the magnetization free layer, the magnetostriction is reduced to zero, and if the magnetization free layer having the above composition is disposed, and the material for the cap layer is formed of the Ta film, the MR ratio becomes lower than 40% when the RA is equal to 3 Ωμm², as shown in FIG. 11. In contrast, if the magnetization free layer having the composition is disposed, and the material for the cap layer is formed of the Ti film, as shown in FIG. 11, the MR ratio becomes higher than 50% when the RA is equal to 3 Ωμm², which makes it possible to use the TMR element as the reading element of the sensitive magnetic head without causing any problem.

From the above-described view points, it can be said that when the TMR element is used as the reading element of the magnetic head, it is effective to use the MgO film for the tunnel barrier layer, use the CoFeB film for the magnetization free layer, and use the Ti film as the material for the cap layer immediately above the magnetization free layer. In this case, when the B composition of the CoFeB film is set to 20 atom %, as described above, by taking the magnetostriction and the obtained MR ratio into account, the Co composition of the CoFeB film is set to approximately 60 atom % to 80 atom % (Fe composition being set to O atom % to 20 atom %), preferably approximately 60 atom % to 75 atom % (Fe composition being set to 5 atom % to 20 atom %), and more preferably 75 atom % (Fe composition being set to 5 atom %).

It should be noted that when the TMR element is used as the memory element of the MRAM, it is only required to use a CoFeB film having an optimum composition by taking the obtained MR ratio into account, since the magnetostriction of the magnetization free layer has no essential influence on the characteristic of the TMR element.

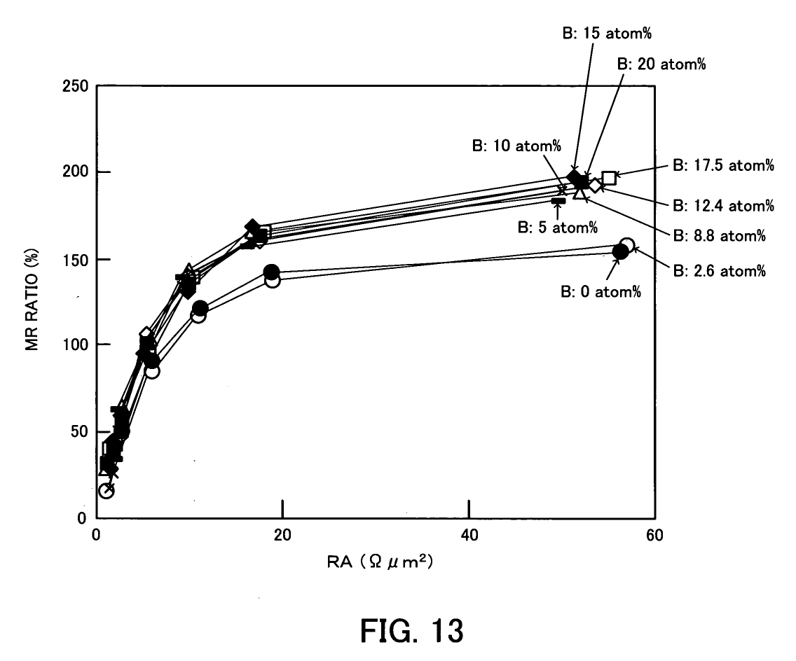

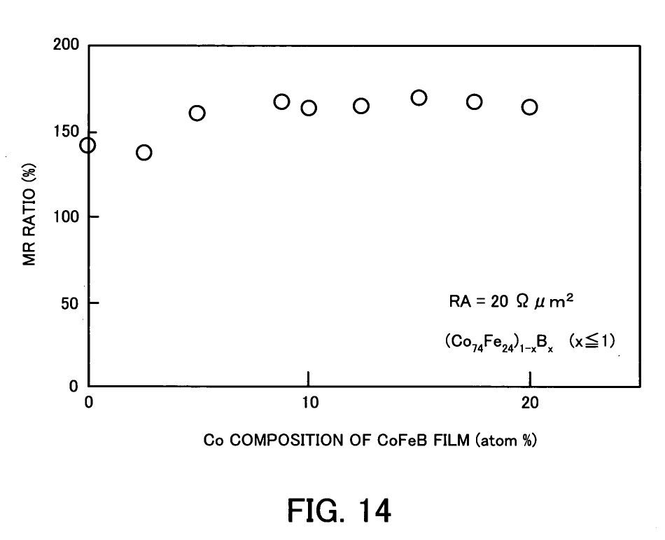

FIG. 13 is a diagram showing the relationship between the RA and the MR ratio which varies with the parameter of the B composition of the CoFeB film of the magnetization free layer. FIG. 14 is a diagram showing the relationship between the B composition of the CoFeB film of the magnetization free layer and the MR ratio. It should be noted that in FIG. 13, the horizontal axis represents the RA (Ωμm²), and the vertical axis represents the MR ratio (%). Further, in FIG. 14, the horizontal axis represents the B composition (atom %) of the CoFeB film, and the vertical axis represents the MR ratio (%) obtained when the RA was equal to 20 Ωμm². However, FIGS. 13 and 14 show the results of measurement of samples of Sample X in Table 1, which had no Cap film formed thereon, that is, which had a cap layer formed of the Ta/Ru multilayered film.

It is understood from FIG. 13 that when the B composition of the CoFeB film was not lower than 5 atom %, a high MR ratio was obtained. Further, it is understood from FIG. 14 that when the RA was equal to 20 Ωμm², the MR ratio was approximately 140% when the B composition was lower than 5 atom %, whereas when the B composition was not lower than 5 atom %, the MR ratio became approximately constant at 165%.

From this, it is preferable that the B composition of the CoFeB film is set to a value not lower than 5 atom %. Further, when the MR ratio and the Co and Fe compositions (i.e. magnetostriction) as shown in FIGS. 11 and 12 are taken into account, it is preferable that the B composition of the CoFeB film is set to a value between 5 atom % and 25 atom %. The same applies to the case where the cap layer was formed of the Ti/Ta/Ru multilayered film.

As described hereinbefore, by configuring the TMR element such that the tunnel barrier layer is formed of the MgO film, the magnetization free layer by the CoFeB film, and the cap layer by forming the Ti film immediately above the CoFeB film of the magnetization free layer, it is possible to make the MR ratio of the TMR element much higher than when the Ta film or a like material other than the Ti film is used immediately above the CoFeB film. In this case, by properly setting the thickness and the composition of the CoFeB film and the thickness of the Ti film according to required characteristics of the TMR element, it is possible not only to further enhance the MR ratio of the TMR element but also to control the MR ratio by such settings.

Hereinafter, a description will be given of respective cases which the TMR element configured as above is applied to the magnetic head and the MRAM.

First, a description will be given of an example of application of the TMR element to the magnetic head.

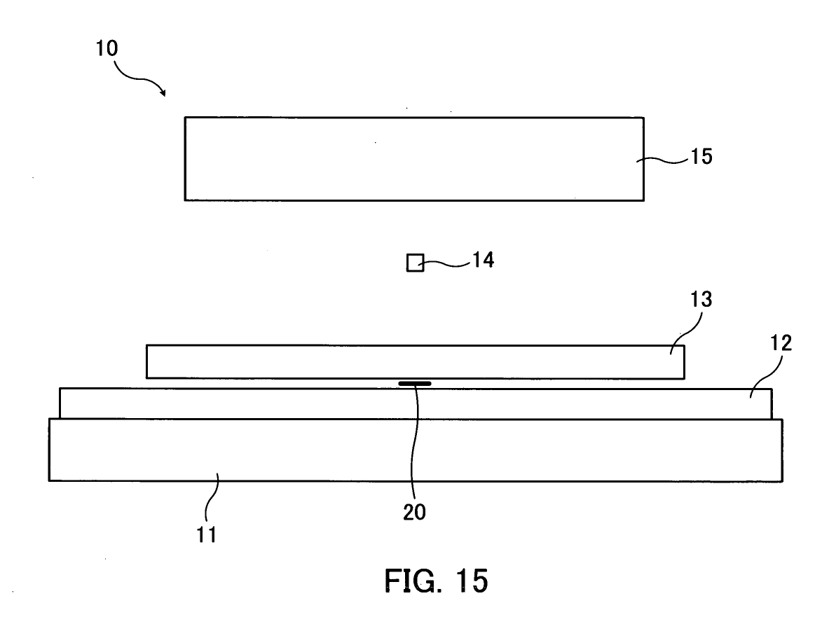

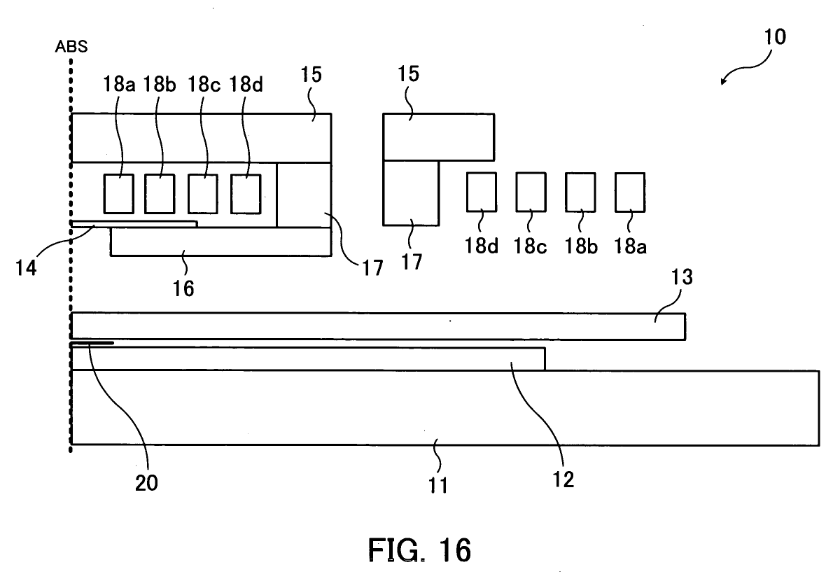

FIG. 15 is a schematic front view of the magnetic head, as viewed from a surface side of the magnetic head facing toward a magnetic recording medium. FIG. 16 is a schematic cross-sectional view of the magnetic head.

As shown in FIGS. 15 and 16, the magnetic head 10 is configured such that a reading element 20 held between a lower magnetic shield layer 12 and an upper magnetic shield layer 13, a main magnetic pole layer 14, and an auxiliary magnetic pole layer 15 are arranged on a circuit board 11 serving as a slider, on a surface side of the magnetic head 10 facing toward a magnetic recording medium, that is, toward an ABS (Air Bearing Surface) indicated by a dotted line in FIG. 16. As shown in FIG. 16, the main magnetic pole layer 14 is formed in part over a main magnetic pole-supporting layer 16. The main magnetic pole-supporting layer 16 and the auxiliary magnetic pole layer 15 formed upward thereof are connected by a connecting layer 17. Further, a plurality of coils 18a, 18b, 18c, and 18d are provided in a manner extending between the main magnetic pole layer 14 and the main magnetic pole-supporting layer 16, and the auxiliary magnetic pole layer 15. The above-described TMR element is used as the reading element 20 of the magnetic head 10 configured as above.

It should be noted that major portions between the lower magnetic shield layer 12, the reading element 20, the upper magnetic shield layer 13, the main magnetic pole-supporting layer 16, the main magnetic pole layer 14, the connecting layer 17, the coils 18a, 18b, 18c, and 18d, and the auxiliary magnetic pole layer 15 are filled with an insulating film, such as AlO, not shown.

Now, a method of forming the magnetic head 10 configured as above will be described, by mainly referring to the reading element 20.

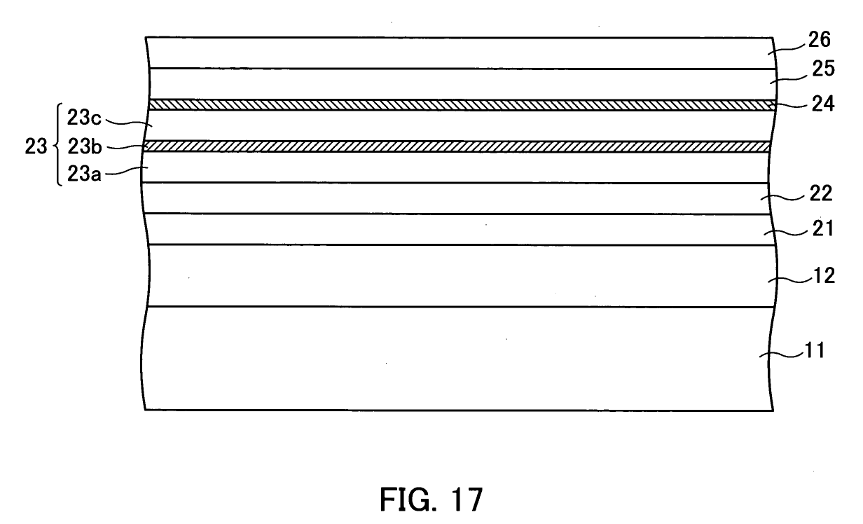

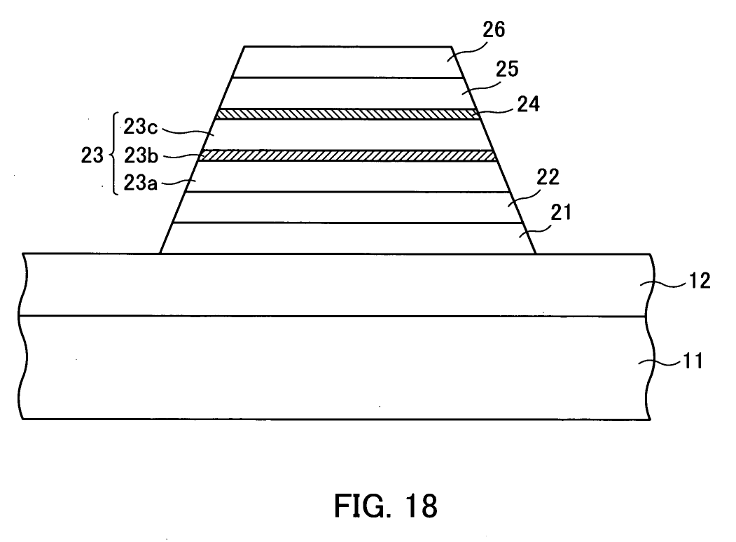

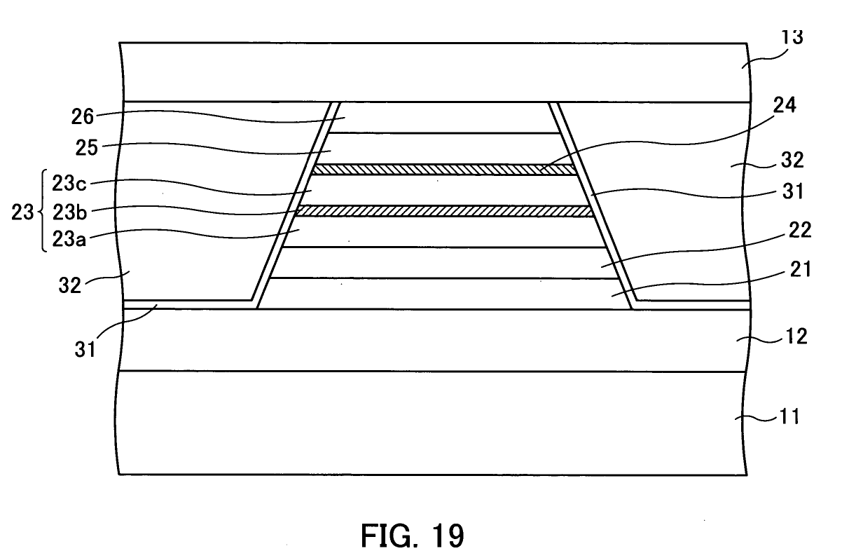

FIGS. 17 to 19 are views which are useful in explaining the method of forming the reading element of the magnetic head. FIG. 17 is a schematic cross-sectional view useful in explaining an essential part of a film-forming process step. FIG. 18 is a schematic cross-sectional view useful in explaining an essential part of an ion-milling process step. FIG. 19 is a schematic cross-sectional view useful in explaining an essential part of a filling process step. It should be noted that FIGS. 17 to 19 are all schematic cross-sectional views, as viewed from the ABS side.

First, as shown in FIG. 17, an AlO film, not shown, is formed over the non-magnetic circuit board 11, such as an AlTiC circuit board, which serves as a slider, and the lower magnetic shield layer 12 made e.g. of NiFe is formed over the AlO film such that the layer 12 has a thickness of approximately 2 μm to 3 μm. The lower magnetic shield layer 12 has a magnetic shield function, and also serves as a lower terminal of the reading element 20. The reading element 20 is formed over the lower magnetic shield layer 12 configured as described above. The films forming the reading element 20 are formed by the sputtering method.

On the lower magnetic shield layer 12, first, a base layer 21 having a thickness of 5 nm or more is formed. The base layer 21 is formed e.g. by a Ta/Ru multilayered film, a NiCr film, or a Ta/NiFe multilayered film. Alternatively, a nickel iron chrome (NiFeCr) film may be used for the base layer 21.

Then, an antiferromagnetic layer 22 having a thickness of approximately 5 nm is formed over the base layer 21. The antiferromagnetic layer 22 is formed e.g. by an IrMn film, a PtMn film, or a PdPtMn film.

Subsequently, over the antiferromagnetic layer 22, a CoFe film having a thickness of approximately 1.5 nm is formed as a first ferromagnetic layer 23a, and over the CoFe film, an Ru film having a thickness of approximately 0.7 nm is formed as a non-magnetic layer 23b. Further, over the Ru film, a CoFeB film having a thickness of approximately 2.5 nm is formed as a second ferromagnetic layer 23c. The first ferromagnetic layer 23a, the non-magnetic layer 23b, and the second ferromagnetic layer 23c form a magnetization fixed layer 23.

Then, over the magnetization fixed layer 23, an MgO film having a thickness of approximately 1 nm is formed as a tunnel barrier layer 24, and over the MgO film, a CoFeB film having a thickness of approximately 3 nm is formed as a magnetization free layer 25.

Then, over the magnetization free layer 25, a Ti film having a thickness of 2 nm or more is formed as a cap layer 26, and over the Ti film, a Ta film having a thickness of approximately 5 nm, and an Ru film having a thickness of approximately 10 nm are formed, one upon the other, whereby a Ti/Ta/Ru multilayered film is formed.

As described above, the base layer 21, the antiferromagnetic layer 22, the magnetization fixed layer 23, the tunnel barrier layer 24, the magnetization free layer 25, and the cap layer 26 are formed in the mentioned order, whereby a TMR film as shown in FIG. 17 is formed.

On the TMR film formed as above, a resist mask, not shown, having a predetermined shape is formed by a photoresist method, and ion-milling is performed on the TMR film until the lower magnetic shield layer 12 is exposed, whereby the TMR film is processed into a shape as shown in FIG. 18. This processing forms the reading element 20.

After the processing, as shown in FIG. 19, first, an insulating film 31 having a thickness of 3 nm to 10 nm is formed over the whole surface of the circuit board 11 by the sputtering method with the resist mask left behind. After that, cobalt chrome platinum (CoCrPt) is deposited on the insulating film 31 by the sputtering method, and a magnetic domain control film 32 is formed over opposite sides of the reading element 20 via the insulating film 31. Subsequently, the resist mask is removed, and portions of the insulating film 31 and the magnetic domain control film 32 on the upper surface of the cap layer 26 are lifted off. After the surface of the magnetic domain control film 32 is flattened, the upper magnetic shield layer 13 made e.g. of NiFe is formed over the reading element 20 and the magnetic domain control film 32 such that the upper magnetic shield layer 13 has a thickness of approximately 2 μm to 3 μm. The upper magnetic shield layer 13 not only has a magnetic shield function, but also serves as an upper terminal of the reading element 20.

The basic configuration of the reproduction head section of the magnetic head 10 is completed by the above-described process steps.

After that, as shown in FIGS. 15 and 16, first, an AlO film or the like is formed over the whole surface by the sputtering method, and then the main magnetic pole-supporting layer 16, which is made of NiFe and has a thickness of approximately 1 μm to 3 μm (e.g. 1 μm), is formed using a selective electrolytic plating method. It should be noted that detailed description of an electrolytic plating process step is omitted.

Subsequently, an AlO film or the like is formed over the whole surface by the sputtering method, and then is made flat to the level of the surface of the main magnetic pole-supporting layer 16, whereby a concave portion formed over the ABS side of the main magnetic pole-supporting layer 16 is filled. Thus, the main magnetic pole-supporting layer 16 is configured such that it is not exposed to the ABS.

Then, the main magnetic pole layer 14 comprising a vertical magnetization film and a soft magnetic film is formed by the sputtering method, and is ion-milled using the resist mask having a predetermined shape. After that, the coils 18a, 18b, 18c, and 18d, the connecting layer 17, the auxiliary magnetic pole layer 15, and so forth are formed in the mentioned order, while forming an AlO film or the like.

The basic configuration of the recording head portion of the magnetic head 10 is completed by the above-described process steps carried out after formation of the reproduction head section.

In the magnetic head 10 formed as described above, the direction of magnetization of the magnetization free layer 25 is changed according to a magnetic field generated based on information recorded in the magnetic recording medium, whereby the resistance value of the reading element 20 is changed. The change in the resistance value is electrically detected, whereby information recorded in the magnetic recording medium is read.

Next, a description will be given of an example of application of the TMR element to the MRAM.

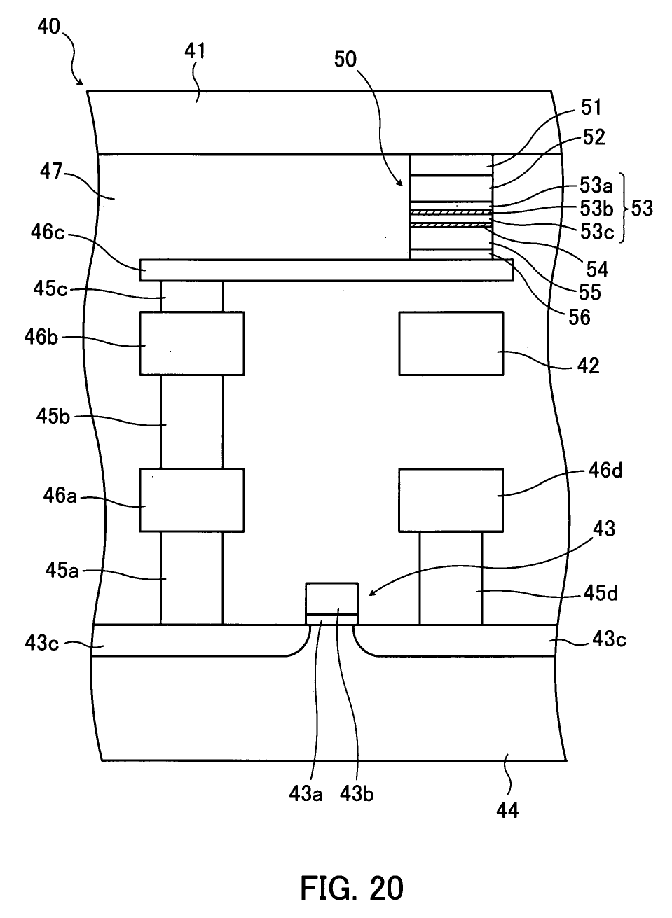

FIG. 20 is a schematic cross-sectional view of essential part of the MRAM.

As shown in FIG. 20, in the MRAM 40, the TMR element 50 is disposed as a memory element at a location of intersection of a bit line 41 used for reading/writing, and a word line 42 used for writing, to thereby form a memory cell. Normally, in the MRAM 40, the TMR elements 50 are arranged at respective intersections between a plurality of bit lines 41 and a plurality of word lines 42 arranged in the form of a matrix, whereby the MRAM is provided with a large number of memory cells.

Each TMR element 50 comprises a wiring layer 51, an antiferromagnetic layer 52, a magnetization fixed layer 53, a tunnel barrier layer 54, a magnetization free layer 55, and a cap layer 56, which are formed one upon another from the side of the bit line 41. The magnetization fixed layer 53 is formed of a multilayered structure of a first ferromagnetic layer 53a, an antiferromagnetic layer 53b, and a second ferromagnetic layer 53c. The TMR element 50 is provided with a Ti film as the material for a cap layer in contact with the magnetization free layer 55. This makes it possible to realize a high MR ratio, that is, a high-power MRAM 40.

Furthermore, the MRAM 40 is provided with a switching transistor 43 for selecting a memory cell during reading. The switching transistor 43 is formed e.g. as a MOS (Metal Oxide Semiconductor) field effect transistor, and a gate electrode 43b is formed over a semiconductor substrate 44 via a gate-insulating film 43a. Source/drain regions 43c are formed over opposite sides of the gate electrode 43b. The switching transistor 43 is electrically connected to the magnetization free layer 55 of the TMR element 50 via plugs 45a, 45b, 45c, and 45d connected to one of the source/drain regions 43c, and wiring layers 46a, 46b, 46c, and 46d.

It should be noted that an insulating film 47, such as SiO, fills between the switching transistor 43, the plugs 45a, 45b, 45c, and 45d, the wiring layers 46a, 46b, 46c, and 46d, the word line 42, the TMR element 50, and the bit line 41, which are formed over the semiconductor substrate 44.

The TMR element 50 can be formed by forming each layer thereof by the sputtering method, and patterning the layer into a predetermined shape. The bit line 41, the word line 42, the switching transistor 43, the plugs 45a, 45b, 45c, and 45d, the wiring layers 46a, 46b, 46c, and 46d, the insulating film 47, and so forth, which form the other portions of the MRAM 40, can be formed according to the conventional semiconductor process.

In the MRAM 40, information of “1” and “0” is defined depending on whether the direction of magnetization of the magnetization free layer 55 is parallel (the resistance of the TMR element 50 is small) or antiparallel (the resistance of the TMR element 50 is large) to the direction of magnetization of the magnetization fixed layer 53. When information is written, while inverting the direction of magnetization of the magnetization free layer 55 of a specific TMR element 50 by a composite magnetic field generated by currents caused to flow through a specific bit line 41 and a specific word line 42, and information of “1” or “0” is written in each specific TMR element 50 according to the direction of the magnetization. Further, when information is read out, a current is allowed to flow though each specific TMR element 50 by using the bit line 41 and the switching transistor 43, and whether or not the resistance of the specific TMR element 50 is large is determined, whereby information recorded in each specific TMR element 50 is read out.

It should be noted that the above-described configuration of the magnetic head 10, and that of the MRAM 40 are presented by way of example, and therefore the present invention can be similarly applied to a magnetic head and an MRAM otherwise configured.

In the present invention, the TMR element is formed by forming a magnetization free layer formed of a CoFeB film over a tunnel barrier layer formed over a magnetization fixed layer, and forming a cap layer over the magnetization free layer such that a Ti film of the cap layer is in contact with the magnetization free layer. This makes it possible to increase the MR ratio of the TMR element. Further, by using the TMR element configured as above as the reading element of a magnetic head and the memory element of a magnetic memory, it is possible to increase the performances of the magnetic head and the magnetic memory.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A tunnel magnetoresistance element comprising:
a magnetization fixed layer having a direction of magnetization thereof fixed;
a tunnel barrier layer formed over said magnetization fixed layer;
a magnetization free layer formed over said tunnel barrier layer, and formed of a CoFeB film such that a direction of magnetization thereof is variable;
a cap layer including a Ti film, and formed over said magnetization free layer such that said Ti film is in contact with said magnetization free layer.

2. The tunnel magnetoresistance element according to claim 1, wherein said tunnel barrier layer is formed of an MgO film.

3. The tunnel magnetoresistance element according to claim 1, wherein said CoFeB film has a Co composition of 60 atom % to 80 atom %.

4. The tunnel magnetoresistance element according to claim 3, wherein said CoFeB film has a B composition of 20 atom %.

5. The tunnel magnetoresistance element according to claim 1, wherein said CoFeB film has a B composition of 5 atom % to 25 atom %.

6. The tunnel magnetoresistance element according to claim 1, wherein said magnetization free layer has a thickness of 0.5 nm to 6 nm.

7. The tunnel magnetoresistance element according to claim 1, wherein said cap layer has a thickness of 0.5 nm to 5 nm.

8. A magnetic head using a tunnel magnetoresistance element as a reading element, wherein the tunnel magnetoresistance element comprises:
a magnetization fixed layer having a direction of magnetization thereof fixed;
a tunnel barrier layer formed over said magnetization fixed layer;
a magnetization free layer formed over said tunnel barrier layer, and formed of a CoFeB film such that a direction of magnetization thereof is variable;
a cap layer including a Ti film, and formed over said magnetization free layer such that said Ti film is in contact with said magnetization free layer.

9. The magnetic head according to claim 8, wherein said tunnel barrier layer is formed of an MgO film.

10. The magnetic head according to claim 8, wherein said CoFeB film has a Co composition of 60 atom % to 80 atom %.

11. The magnetic head according to claim 8, wherein said CoFeB film has a B composition of 5 atom % to 25 atom %.

12. The magnetic head according to claim 8, wherein said magnetization free layer has a thickness of 0.5 nm to 6 nm.

13. The magnetic head according to claim 8, wherein said cap layer has a thickness of 0.5 nm to 5 nm.

14. A magnetic memory using a tunnel magnetoresistance element as a memory element, wherein the tunnel magnetoresistance element comprises:
a magnetization fixed layer having a direction of magnetization thereof fixed;
a tunnel barrier layer formed over said magnetization fixed layer;
a magnetization free layer formed over said tunnel barrier layer, and formed of a CoFeB film such that a direction of magnetization thereof is variable;
a cap layer including a Ti film, and formed over said magnetization free layer such that said Ti film is in contact with said magnetization free layer.

15. The magnetic memory according to claim 14, wherein said tunnel barrier layer is formed of an MgO film.

16. The magnetic memory according to claim 14, wherein said CoFeB film has a Co composition of 60 atom % to 80 atom %.

17. The magnetic memory according to claim 14, wherein said CoFeB film has a B composition of 5 atom % to 25 atom %.

18. The magnetic memory according to claim 14, wherein said magnetization free layer has a thickness of 0.5 nm to 6 nm.

19. The magnetic memory according to claim 14, wherein said cap layer has a thickness of 0.5 nm to 5 nm.
